(19) United States
(12) Patent Application Publication
(10) Pub. No.: US 2008/0031606 A1
(43) Pub. Date: Feb. 7, 2008

(54) FLIP GRIP HINGE ARRANGEMENT FOR ELECTRONIC DEVICES

(75) Inventors: GLENN S. ZAX, BOYNTON BEACH, FL (US); NEIL J. SCHMERTMANN, BOYNTON BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/462,451

(22) Filed: Aug. 4, 2006

(51) Int. Cl. G03B 17/00

(52) U.S. Cl. 396/56

(57) ABSTRACT

An electronic device (100 or 200) can include a grip handle member (204) having at least one electronic function, and a core device (202) pivotably coupled to the grip handle member. The grip handle member can include among a microphone (210) and a speaker (208) on opposing ends of the grip handle, a camera or video camera (206 or 250) that can have a pop-out camera lens or a pivoting camera lens. The grip handle member can include at least one loudspeaker (207). The core device can further include a display or touch screen (212) or a transceiver (117) and an antenna (119) within the core device or the grip handle member or both. The electronic device can be any number of devices including a cellular, camera or smart phone, two-way radio, cordless phone, laptop computer, personal digital assistant, camera, video camera, video conferencing device, or any combination thereof.

### FIELD

This invention relates generally to a grip hinge or handle arrangement, and more particularly to a grip hinge arrangement for portable electronic devices.

### BACKGROUND

Electronic devices such as phones, personal digital assistance, cameras, and MP3 players come in various form factors including various monolith and flip form factors. Although existing form factors each have their own special utility, none can claim to simultaneously help reduce specific absorption rates, reduce the chances of getting face grease or oils on a device's display, and further provide microphone and speaker isolation by providing microphones and speakers at opposite ends of a handle or grip. The monolith or flip form factors provide a couple of modes of functionality, but the number of modes and flexibility of operations of such devices can be limited inherently by their current form factor.

### SUMMARY

Embodiments in accordance with the present invention can provide a form factor for electronic devices that uses a flip grip hinge that enables greater flexibility in design and functionality, particularly when the electronic devices incorporate multimedia functions such as camera, video, audio, text, or phone functions.

In a first embodiment of the present invention, an electronic device can include a grip handle member having at least one electronic function, and a core device pivotably coupled to the grip handle member. The at least one electronic function of the grip handle member operates cooperatively with a plurality of functions of the core device. The grip handle member can include among a microphone and a low volume speaker on opposing ends of the grip handle, a camera or a video camera. The grip handle member can further include at least one loudspeaker and can form an acoustic cavity volume. The grip handle member can further include a pop-out camera lens or a pivoting camera lens. The core device can further include a display or touch screen or a transceiver. The electronic device can further include an antenna within the core device or the grip handle member or both. The electronic device can further include a touch screen and a removable stylus within the core device that in a first stored position prevents a relative pivoting between the core device and the grip handle member and in a second stored position unlocks the cored device from grip handle member enabling the relative pivoting. The core device can include an input/output port or charger port that is protected when the grip handle member is in a closed position with respect to the core device and is exposed when the grip handle member is in an unlocked position. The electronic device can be any number of devices including a cellular phone, a two-way radio, a cordless home phone, a laptop computer, a personal digital assistant, a camera phone, a smart phone, a camera, a video camera, a video conferencing device, or any combination thereof.

In a second embodiment of the present invention, a portable communication device can include a grip handle member having a earpiece speaker on a first end and a microphone on a second end, a core device pivotably coupled to the grip handle member at a pivot point, and an antenna and a transceiver in the grip handle member or the core device, where the antenna substantially remains at least as far away from a user as the pivot point. The grip handle member can further include a camera or a video camera that includes a pop-out camera lens or a pivot camera lens. The grip handle member can further include at least one loudspeaker. The grip handle member can also include an acoustic cavity volume. The core device can further include a display or touch screen. The portable communication device can further include and a removable stylus within the core device that in a first stored position prevents a relative pivoting between the core device and the grip handle member and in a second stored position unlocks the cored device from grip handle member enabling the relative pivoting.

In a third embodiment of the present invention, a portable communication device can include a grip handle member having a earpiece speaker on a first end and a microphone on a second end, a core device pivotably coupled to the grip handle member at a pivot point, an antenna and a transceiver in the grip handle member or the core device, and a camera or video camera in the grip handle member. The camera or video camera can further include a pop-out camera lens or a pivot camera lens.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an electronic device including a grip handle member in accordance with an embodiment of the present invention.

FIG. 2 is an illustration of another electronic device including a grip handle member in accordance with another embodiment of the present invention.

FIG. 3 is an illustration of the electronic device of FIG. 1 with a core device pivoted in relation to the grip handle member in accordance with an embodiment of the present invention.

FIG. 4 is an illustration of the electronic device of FIG. 1 oriented with a speaker, microphone, and display in a front plan view enabling ambidextrous use of the grip handle member in accordance with an embodiment of the present invention.

FIG. 5 is a close up side view of the electronic device of FIG. 1 illustrating how a stylus stored in the core device mates with the grip handle member in accordance with an embodiment of the present invention.

FIG. 6 is a perspective view of the electronic device of FIG. 1 with the stylus being removed from the core device enabling relative pivoting in accordance with an embodiment of the present invention.

FIG. 7 is a front plan view of the electronic device of FIG. 1 illustrating the stylus used on a touch sensitive display in accordance with an embodiment of the present invention.

FIG. 8 is the electronic device of FIG. 2 in an entertainment configuration in accordance with an embodiment of the present invention.

FIG. 9 is the electronic device of FIG. 2 in person to person or video conferencing configuration in accordance with an embodiment of the present invention.

FIG. 10 is the electronic device of FIG. 2 in a camera mode looking away from a user in accordance with an embodiment of the present invention.

FIG. 11 is the electronic device of FIG. 2 in a camera mode where the display points up and the camera point out away from a user in accordance with an embodiment of the present invention

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

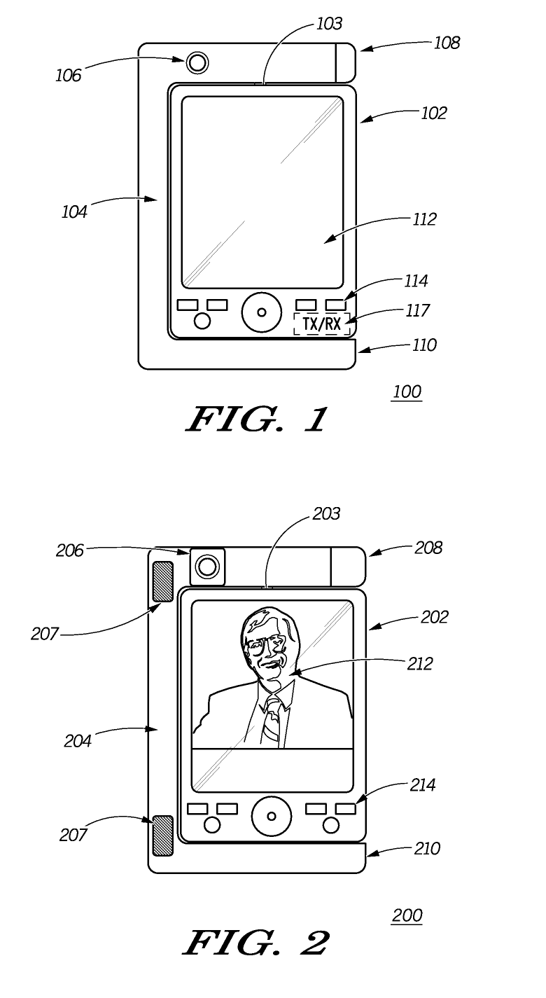

Embodiments herein can be implemented in a wide variety of exemplary ways. For example, FIGS. 1 and 2 illustrate to alternative embodiments of an electronic device having a hinge grip member. In FIG. 1, an electronic device 100 includes two housings in the form of a main core device 102 and a hinge grip member 104 pivotably coupled to each other at one or more pivot points (103) to form a handle-stand device (100) such that the core device 102 is protected and can rotate within the “handle” 104. The handle-stand device can be utilized to act as a device handle and stand and can provide a compartment for additional features (both electronic and mechanical). The core device can contain electronics for interfacing to a user with a wide range of features including but not limited to a transceiver 117, a display or touch screen 112, a key pad input 114, processor, battery or batteries, or memory that can form part of a personal digital assistant, laptop computer, camera, video camera, Digital audio/video player, Internet access device, two-way radio, cellular phone, voice recorder, or other similar device or combination thereof.

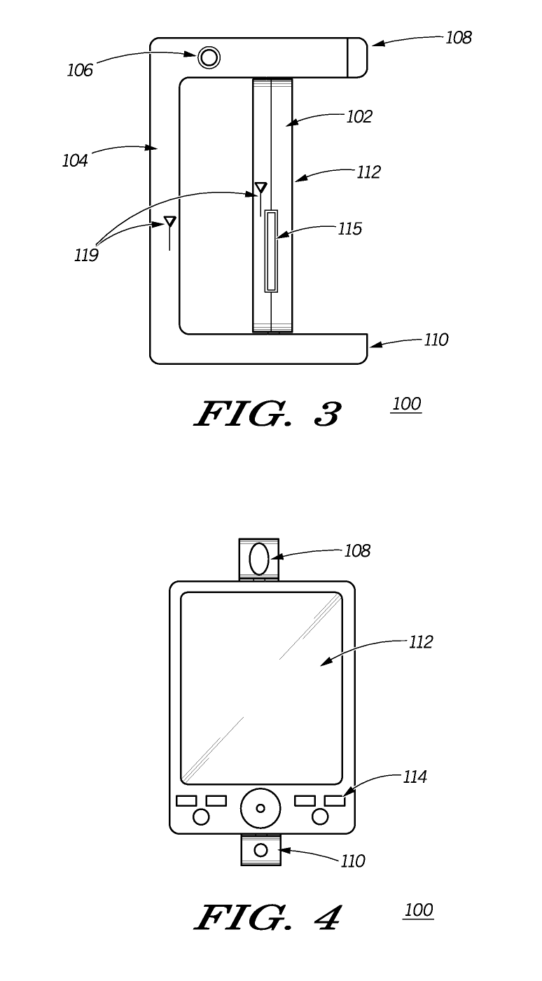

As can be noted in FIGS. 3 and 4, the core device 102 can pivot at two ends within the outer “handle” 104 in such manner that the handle acts as a stop to prevent full 360 degree motion that could sever a flexible circuit if used (but can also be adjusted for 360 degree rotation if another communication method is used between the core and the handle devices (e.g. wireless such as Bluetooth). The handle grip member 104 can come in a substantially U-shaped form and can include an earpiece speaker or low volume speaker 108 on a first end and a microphone 110 on an opposing or second end. The handle grip member can further include a camera 106 or other device as well. Connectors or ports 115 as seen in FIG. 3 on the core device 102 and the peripherals on the handle (e.g., cameras if pivotable or made to pop in or out as in electronic device 200 of FIG. 2) can be protected by orienting them to face the wall of the other housing (i.e., handle grip member). In other words, the ports 115 can be protected when the core device 102 is in a closed position and exposed in an open or pivoted or rotated position as shown in FIGS. 3 and 4.

As shown in FIGS. 3 and 4, the handle grip member 104 provides a comfortable means for holding the device 100 during a phone call for example and enables ambidextrous use of the device. In other words, the handle grip member 104 enables equal phone use for either left handed or right handed use or orientation. The electronic device 100 can further include an antenna 119 in either the handle grip member 104 or the core device 102 or both. As can be noted in FIG. 3, not only can such arrangement reduce the chance of getting face grease, oil, or makeup on the display 112, but the antenna (119) placement can be such a distance to a user face reducing or eliminating alleged concerns over Specific Absorption Rates (SAR) or other similar issues. The antenna(s) 119 in such arrangement would be substantially placed at least as far away as the pivot point either embedded in the handle grip member 104 or core device 102.

An electronic device having a hinge utility as contemplated herein provides a unique way of handling and packaging electronics in a manner that provide versatility in a multitude of applications as further demonstrated by the electronic device 200 of FIG. 2. The electronic device 200 is similar to electronic device 100 in that it can include a core device 202, a handle grip member 204 where the core device can include a display 212 and keypad 214 and the handle grip member can include an earpiece speaker 208 and microphone 210. The core device 202 can pivot about one or more pivot points (203). The handle grip member 204 can further include a pivotable camera 206 that can be turned or twisted in a direction to protect its lens. For example, the camera 206 can be a high resolution camera that can rotate 180 degrees. The handle grip member 204 can further include stereo loudspeakers 207 for loud high quality audio. Note also that in either embodiment, the earpiece speaker and microphone can be acoustically isolated using internal baffles and the handle grip member can provide a sufficient acoustic cavity volume for good audio bass response. The grip handle member 104 can provide space for accommodating other features as desired. Such features can include (in the handle grip member or core device) an internal antenna away from user's head, a touch screen, stereo audio jacks, a main camera that can rotate 180 degrees or a main camera that can rotate into protective (against transceiver) position, a person to person (P2P) camera that can tuck away into the handle grip member, dual microphones for noise cancellation, or sufficient memory to play full length movies or other multimedia presentations.

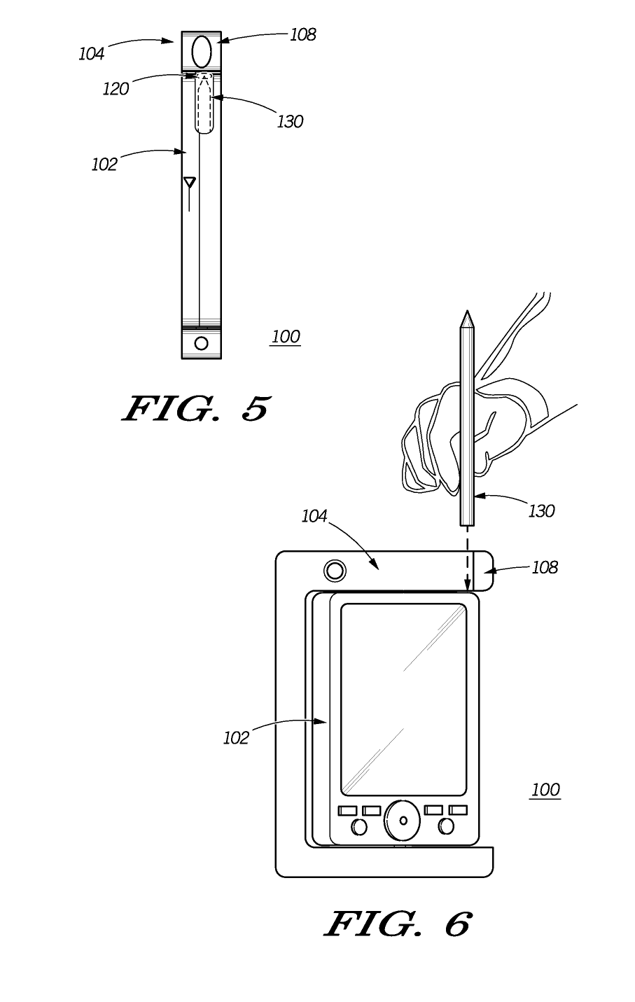

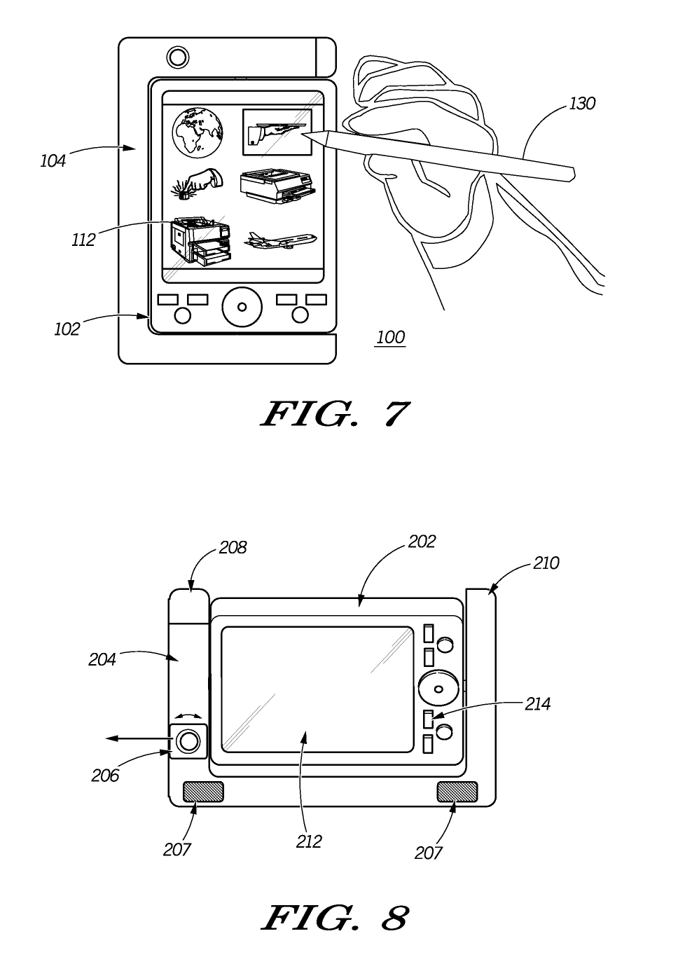

As demonstrated in FIGS. 5 through 7, the electronic device 100 including the handle grip member 104 and core device 102 can accommodate various features such as a stylus latch locking mechanism. Particularly if the display 112 is a touch screen, a stylus 130 can be embedded in a portion of the core device 102 to further serve as a latch or locking mechanism to prevent the core device 102 from rotating or pivoting relative to the handle grip member 104. In a locked position as shown in FIG. 5, a stylus 130 can be locked within a hole or aperture 120 within the handle grip member 104 and particularly within or near the earpiece speaker 108 of the handle grip member 104. The stylus 130 can act as a lock latch and can be “popped down” once to open and twice to release for example. Once the latch is open as shown in FIG. 6, the core device 102 can rotate or pivot and the stylus 130 can be removed and subsequently used on the touch screen 112 as shown in FIG. 112.

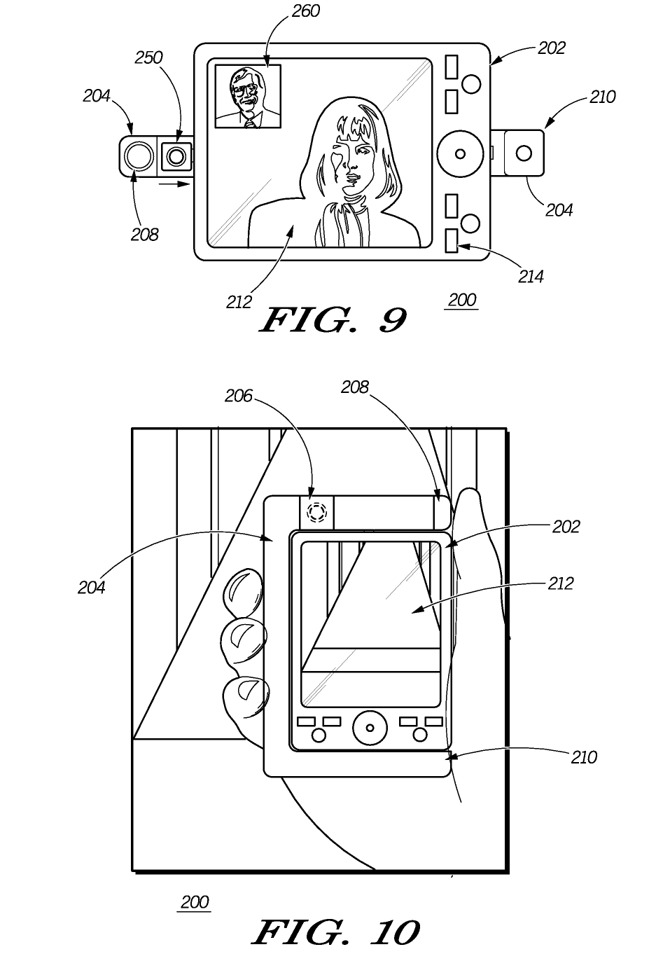

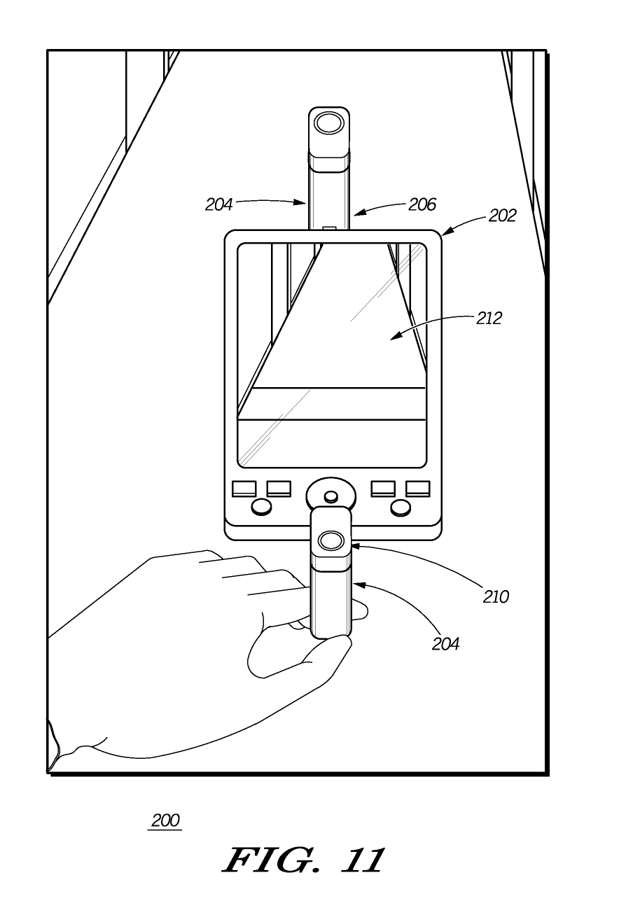

Referring to FIGS. 8-11, the electronic device 200 (or 100) can operate in various mode or configurations such as a passive entertainment mode as shown in FIG. 8, an interactive or video conferencing mode as shown in FIG. 9, and various video or camera modes as illustrated by FIGS. 10 and 11. Note, detents can be added to provide locking at preset angles (video conference mode and viewing mode). Also, placement of the pivot point can prevent display the core device 202 (having a transceiver module for example) from rotating more than 180 degrees and thereby severing or ripping the grip handle member to transceiver connection (if not wireless).

As shown in FIG. 8 with the display 212 facing up and the camera being rotated out or in as desired, the electronic device 200 in a passive entertainment mode can provide a comfortable means to video or photograph an event with the flexibility in setting up a scene to photograph or video. The viewing angle of the display 212 and speakers 207 can be adjusted to suit a particular context and enables a user to watch videos, slide shows, browse the Internet, navigate through applications (using buttons or keypads 214) or a remote controller (not shown). In this example the speakers 207 and display 212 can be made to face a user.

In a Video Conferencing or Person-to-Person (P2P) mode as shown in FIG. 9, the display 212 and a camera 250 can be adjusted for a user's eyes. Instead of a camera that pivots or rotates, the electronic device 200 can include a P2P camera 250 that “pops” out and “tucks” away in the handle grip member 204. It can be designed robustly so as not to shear when a cored device 202 (having a display/transceiver for example) is rotated. The camera 250 can be designed to be activated when deployed. Thus, in such arrangement, the user not only can “see” a caller on their display 212, but can also see themselves within a window 260 using software that presents on the display 212 what the camera 250 “sees”.

Referring to FIGS. 10 and 11, the electronic device 100 can operate in various camera or video modes. In FIG. 10, the camera 206 can be placed looking away from the user with the display 212 facing the user in a portrait orientation. Of course, the grip handle member 204 or core device 202 can be pivoted to various angles and the camera 206 can be rotated as needed. In FIG. 11, the grip handle member 204 can be gripped from below where the display 212 can be pointing up enabling a user to look down at the display 212 and the camera 206 can be pointing out in front of the user. Of course, the configurations and modes shown are not limited to those demonstrated herein.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. An electronic device, comprising:
a grip handle member having at least one electronic function; and
a core device pivotably coupled to the grip handle member, wherein the at least one electronic function of the grip handle member operates cooperatively with a plurality of functions of the core device.

2. The electronic device of claim 1, wherein the grip handle member is U-shaped and further comprises a microphone and a low volume speaker on opposing ends of the grip handle.

3. The electronic device of claim 1, wherein the grip handle member further comprises a camera or a videocamera.

4. The electronic device of claim 1, wherein the core device further comprises a display or touch screen.

5. The electronic device of claim 1, wherein the core device further comprises a transceiver.

6. The electronic device of claim 1, wherein the electronic device further comprises an antenna within the core device or the grip handle member or both.

7. The electronic device of claim 1, wherein the electronic device further comprises a touch screen and a removable stylus within the core device that in a first stored position prevents a relative pivoting between the core device and the grip handle member and in a second stored position unlocks the cored device from grip handle member enabling the relative pivoting.

8. The electronic device of claim 1, wherein the grip handle member further comprises at least one loudspeaker.

9. The electronic device of claim 1, wherein the grip handle member further forms an acoustic cavity volume.

10. The electronic device of claim 1, wherein the grip handle member further comprises a pop-out camera lens or a pivoting camera lens.

11. The electronic device of claim 1, wherein the core device comprises a input/output port or charger port that is protected when the grip handle member is in a closed position with respect to the core device and is exposed when the grip handle member is in an unlocked position.

12. The electronic device of claim 1, wherein the electronic device comprises a cellular phone, a two-way radio, a cordless home phone, a laptop computer, a personal digital assistant, a camera phone, a smart phone, a camera, a video camera, a video conferencing device, or any combination thereof.

13. A portable communication device, comprising:
a grip handle member having a earpiece speaker on a first end and a microphone on a second end;
a core device pivotably coupled to the grip handle member at a pivot point and operates cooperatively with a function of the grip handle member; and
an antenna and a transceiver in the grip handle member or the core device, wherein the antenna substantially remains at least as far away from a user as the pivot point.

14. The portable communication device of claim 13, wherein the grip handle member further comprises a camera or a videocamera that includes a pop-out camera lens or a pivot camera lens.

15. The portable communication device of claim 13, wherein the core device further comprises a display or touch screen.

16. The portable communication device of claim 13, wherein the portable communication device further comprises a touch screen and a removable stylus within the core device that in a first stored position prevents a relative pivoting between the core device and the grip handle member and in a second stored position unlocks the cored device from grip handle member enabling the relative pivoting.

17. The portable communication device of claim 13, wherein the grip handle member further comprises at least one loudspeaker.

18. The portable communication device of claim 13, wherein the grip handle member further forms an acoustic cavity volume.

19. A portable communication device, comprising:
a grip handle member having a earpiece speaker on a first end and a microphone on a second end;
a core device pivotably coupled to the grip handle member at a pivot point;
an antenna and a transceiver in the grip handle member or the core device; and
a camera or video camera in the grip handle member.

20. The portable communication device of claim 19, wherein the camera or video camera further comprises a pop-out camera lens or a pivot camera lens.
